(19) United States
(12) Patent Application Publication
(10) Pub. No.: US 2015/0027402 A1
(43) Pub. Date: Jan. 29, 2015

(54) THRUST PLATE

(71) Applicant: Caterpillar Inc., Peoria, IL (US)

(72) Inventors: Jay C. Landsiedel, Kewanee, IL (US); David G. Turner, Mossville, IL (US); Lucas J. Moehling, Metamora, IL (US)

(73) Assignee: Caterpillar Inc., Peoria, IL (US)

(21) Appl. No.: 13/951,777

(22) Filed: Jul. 26, 2013

(51) Int. Cl. F02F 7/00; F16C 17/04

(52) U.S. Cl. CPC F02F 7/0046; F16C 17/04
USPC 123/198 R; 384/425

(57) ABSTRACT

A system including a stationary housing having a recess formed therein and a thrust plate positioned within the recess in the housing. The thrust plate may have a non-circular profile for preventing rotation of the thrust plate relative to the housing, and may be secured within the recess without the use of fasteners or dowels. The thrust plate may have a body that is generally annular in shape, with one or more ears extending radially from the body.

### TECHNICAL FIELD

The present disclosure relates to a thrust plate, and more specifically to a sacrificial thrust plate for positioning between a rotating surface and a stationary surface.

### BACKGROUND

An engine may include one or more rotating components enclosed within an engine housing. During operation of the engine, the rotating components may tend to contact and rub against the engine housing or other stationary components. This contact between the rotating components and the stationary components may cause excessive wear of the rotating components and/or the stationary components (e.g. engine housing) leading to reduced engine efficiency, frequent service intervals, need for replacements and increased engine downtime. Hence, a thrust plate is often provided as a sacrificial surface between the rotating component and the engine housing. The thrust plate may prevent direct contact between the rotating component and the engine housing and thereby reduce wear experienced by both due to frictional forces.

In known system designs, the thrust plate is affixed to the engine housing using various retention mechanisms like bolts, screws and/or pins. In some situations, additional machining is required in order to accommodate the retention mechanisms. This is a laborious process and may add to the cost of manufacturing. Thus, there is a need for an improved thrust plate design.

European Published Application Number 209,316 discloses a clutch driven plate assembly for an automotive vehicle clutch driving a transmission input shaft. The assembly includes a thrust washer between an outer hub and a spring retainer plate. The thrust washer has circumferentially spaced and axially aligned ears thereon. The spring retainer plate has openings for receiving the ears.

### SUMMARY OF THE DISCLOSURE

In one aspect of the present disclosure, a system is provided. The system includes a housing having a recess formed therein. The system also includes a thrust plate positioned within the recess in the housing. The thrust plate has a non-circular profile for preventing rotation of the thrust plate relative to the housing.

In another aspect of the present disclosure, a thrust plate is provided. The thrust plate includes a body having a generally circular outer periphery, a first planar surface and a second planar surface spaced from and generally parallel to the first planar surface. The thrust plate also includes an ear extending from the outer periphery of the body. The ear has surfaces that are coplanar with the first and second planar surfaces of the body.

In yet another aspect of the present disclosure, an engine is provided. The engine includes an engine block, a flywheel and a flywheel housing with a recess. The engine also includes a rotating component provided in spaced relation to the flywheel housing. The engine further includes a thrust plate provided in the recess. The thrust plate includes a body having a generally circular outer periphery, a first planar surface and a second planar surface. The second planar surface is spaced from and generally parallel to the first planar surface. The thrust plate also includes an ear extending from the outer periphery of the body. The ear has surfaces that are coplanar with the first and second planar surfaces of the body.

Other features and aspects of this disclosure will be apparent from the following description and the accompanying drawings.

### BRIEF DESCRIPTION OF THE DRAWINGS

FIG. 1 is a perspective view of an exemplary engine, according to one embodiment of the present disclosure;

FIG. 2 is an exploded perspective view of a housing, a thrust plate and a rotating component;

FIG. 3 is a perspective view of a recess provided in the housing;

FIG. 4 is a perspective view of the thrust plate according to the concepts of the present disclosure;

FIG. 5 is an exploded perspective view of the recess and the thrust plate;

FIG. 6 is a perspective view of the thrust plate positioned within the recess; and

FIG. 7 is a cross-sectional view of the thrust plate, the rotating component and the housing.

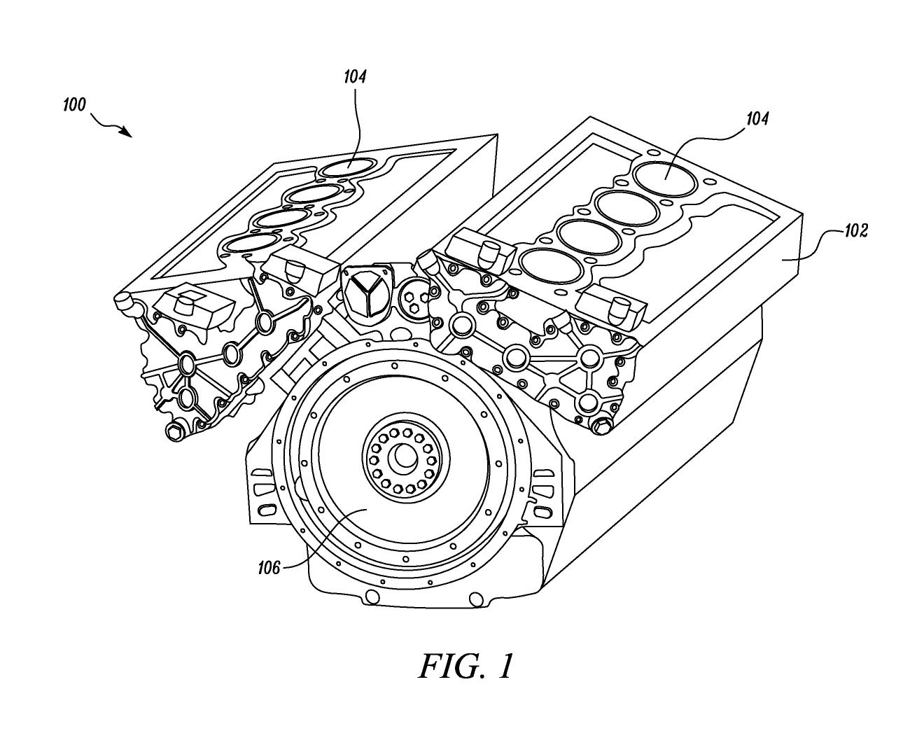

### DETAILED DESCRIPTION

Wherever possible, the same reference numbers will be used throughout the drawings to refer to the same or the like parts. Referring to FIG. 1, an exemplary engine 100 is illustrated. More specifically, the engine 100 may be an internal combustion engine. The engine 100 may be powered by any one or a combination of known liquid or gaseous fuels including, but not limited to, gasoline, diesel, natural gas, petroleum gas and bio-fuels.

The engine 100 may include an engine block 102 and a cylinder head (not shown). The engine block 102 may further include a plurality of cylinders 104. Each of the plurality of cylinders 104 may be configured to receive a piston (not shown). The engine block 102 may further house other components of the engine 100 including, but not limited to, connecting rods, crankshaft, bearings and gears. The engine block 102 may also include a housing 106 for a flywheel (not shown). Additionally, the housing 106 may partially or fully enclose other rotating components including, but not limited to, gears, bearings and shafts.

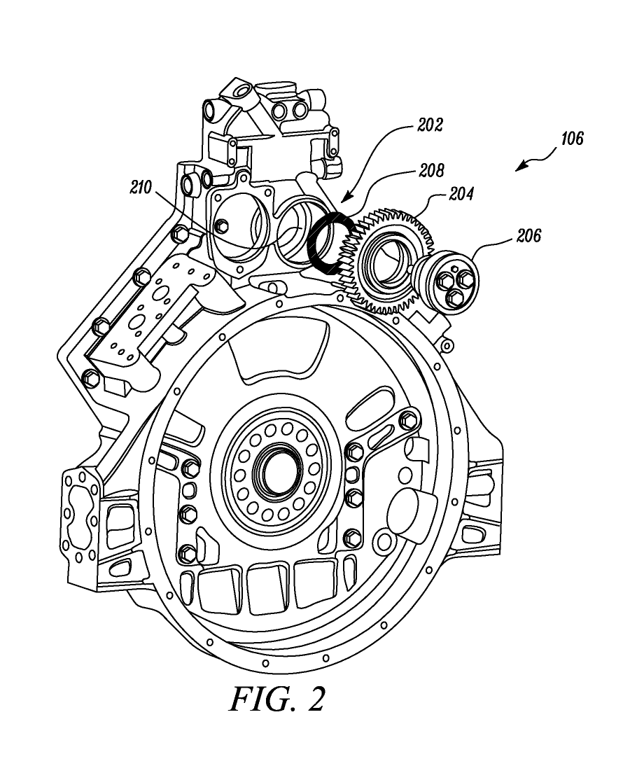

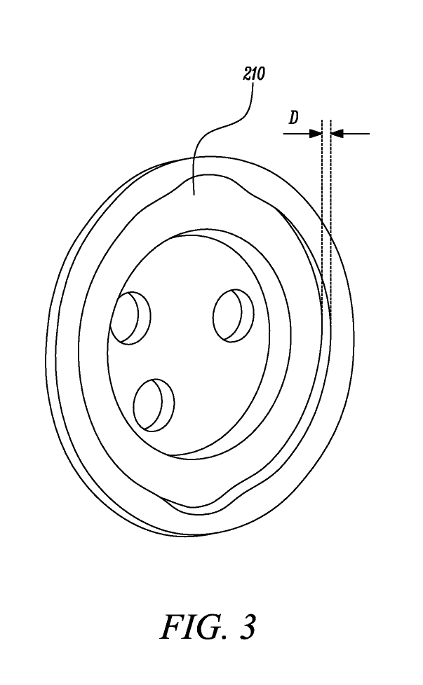

Referring to FIG. 2, an exploded perspective view of the housing 106 is illustrated. The housing 106 may be provided with a pocket 202 to enclose a rotating component like a gear 204. A bearing or a stub shaft assembly 206 may also be provided in the pocket 202 to rotatably mount the gear 204 to the housing 106 within the pocket 202. Further, a thrust plate 208 (shown as a shaded component) may be provided between the gear 204 and the housing 106. The thrust plate 208 may be configured to prevent the gear 204 from contacting and rubbing against the housing 106 when the gear 204 rotates during operation of the engine 100. Accordingly, a recess 210 may be provided in the housing 106 to receive the thrust plate 208. Referring to FIG. 3, a perspective view of the recess 210 is shown. The recess 210 has a defined depth D. The recess 210 may be sized and shaped to correspond to the size and shape of the thrust plate 208.

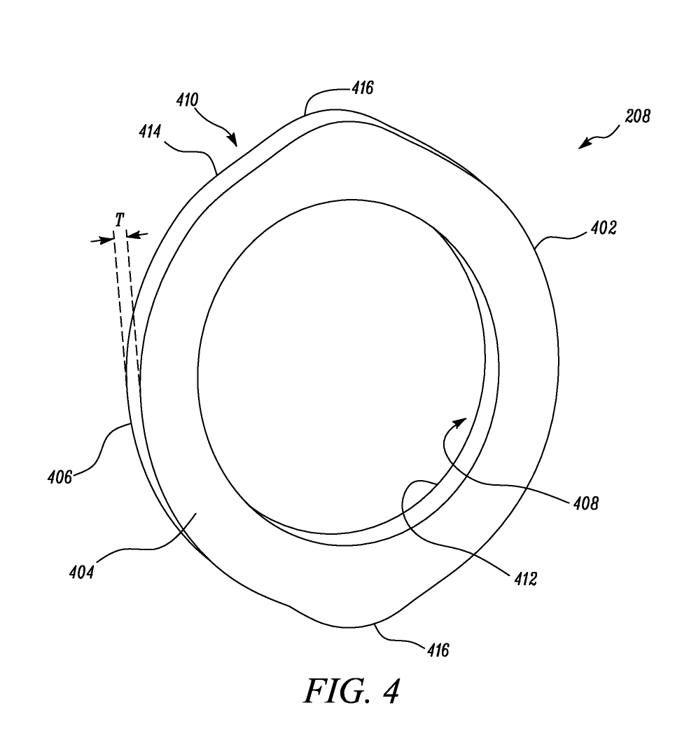

Referring to FIG. 4, a perspective view of the thrust plate 208 is illustrated. The thrust plate 208 may have a body 402 with a substantially annular configuration. Further, the thrust plate 208 may have a first planar surface 404 in spaced apart arrangement from a second planar surface 406. The first planar surface 404 may be substantially parallel to the second planar surface 406 such that the thrust plate 208 has a defined thickness T measured between the first and second planar surfaces 404, 406. As shown, the thrust plate 208 has an inner radial surface 408 and an outer radial surface 410 defining an inner periphery 412 and an outer periphery 414, respectively.

Additionally, the thrust plate 208 may include a radial projection in the form of an ear 416 extending from the outer periphery 414 and/or the inner periphery 412. In certain embodiments, the ear 416 may have a substantially arcuate profile. Alternatively, in other embodiments the ear 416 may be shaped in any desired manner and suitable for the intended application. Surfaces of the ear 416 may be coplanar with the first and second planar surfaces 404, 406 of the thrust plate 208. More specifically, the ear 416 is configured to create a non-circular profile of the thrust plate 208. The non-circular profile of the thrust plate 208 may prevent rotation of the thrust plate 208 within the recess 210 provided in the housing 106.

In the illustrated embodiment, first and second ears 416 are provided diametrically opposite to each other on the outer periphery 414. In another embodiment, the first and second ears 416 may be angularly spaced apart from one another, such that one ear 416 is positioned on the inner periphery 412 and the other ear 416 is positioned on the outer periphery 414. It should be noted that the profile, location and number of the ears 416 provided on the thrust plate 208 may vary as per system design and requirements and may not limit scope of the disclosure.

The thrust plate 208 may be made of any wear resistant material known in the art as per system design and requirements. Accordingly, the thrust plate 208 may be made of any metal or an alloy including, but not limited to, steel, bronze and the like. The material of the thrust plate 208 may be different than a material of the housing 106. The thrust plate 208 may be formed by any known manufacturing process known to one skilled in the art including, but not limited to, casting, forging and/or any sheet metal working process. In a particular embodiment, the thrust plate 208 may be cut from a metal sheet, and may require substantially no further machining following cutting.

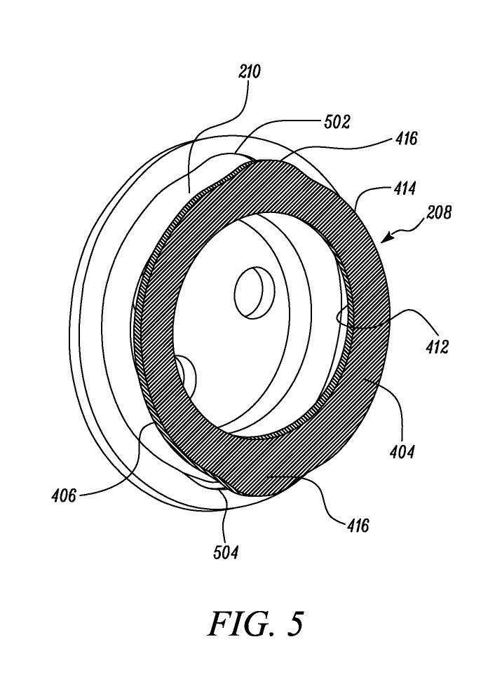

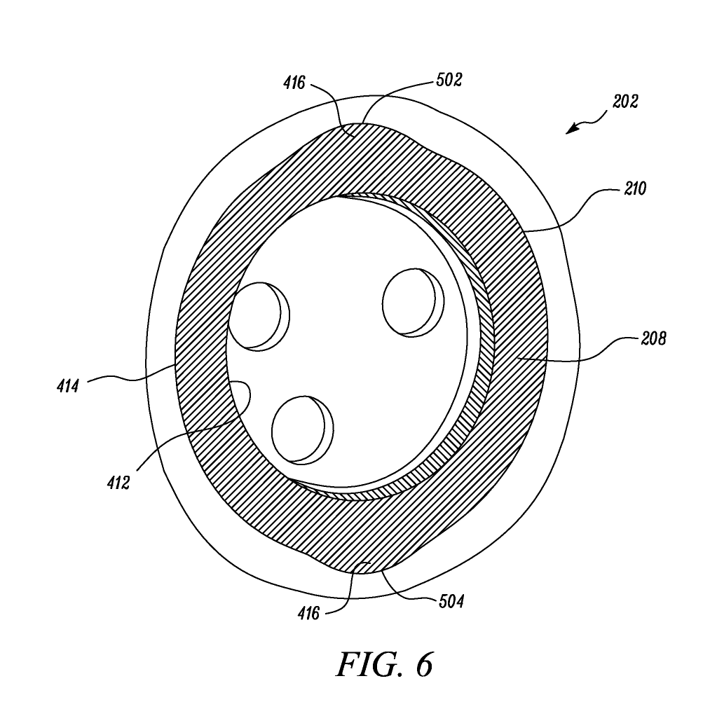

Referring to FIGS. 5 and 6, perspective views of the thrust plate 208 and the recess 210 are illustrated. The profile of the recess 210 is configured to intimately engage the profile of the thrust plate 208. More specifically, for example, when the thrust plate 208 includes the first and second ears 416, then the recess 210 may be shaped to accommodate the thrust plate 208 with first and second depressions 502 and 504. The first and second depressions 502, 504 may be sized and shaped to receive and engage the first and second ears 416. The depth D of the recess 210 may be equal to or less than the thickness T of the thrust plate 208 so that the thrust plate 208 may fit within the recess 210 of the housing 106. In one embodiment, a diameter of the outer periphery 414 of the thrust plate 208 may be greater than a corresponding diameter of the recess 210, in order to create an interference fit of the thrust plate 208 within the recess 210. The interference fit allows for the thrust plate 208 to be affixed within the housing 106 without the need of additional external retention means like bolts, screws, rivets, welds and/or pins.

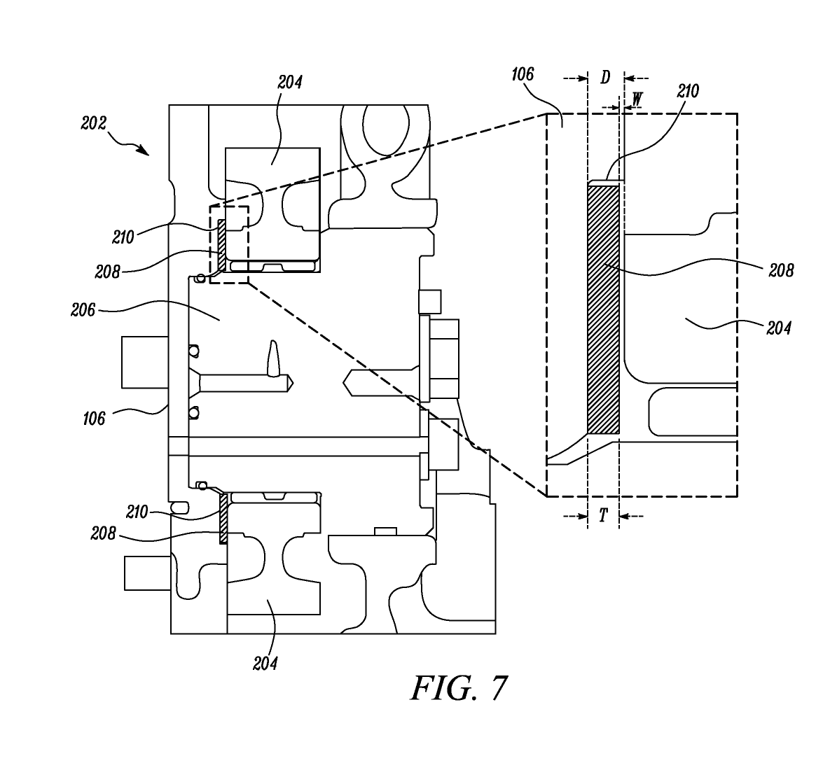

FIG. 7 illustrates a cross-sectional view of the thrust plate 208, the rotating component 204 and the housing 106. During assembly, the thrust plate 208 is received within the recess 210 in pocket 202. The gear 204 is positioned in the pocket 202 adjacent to the thrust plate 208. The gear 204 is rotatably affixed to the housing 106 by the stub shaft assembly 206. As shown in the accompanying figures, a gap is formed between the thrust plate 208 and the rotating component, which is the gear 204. The gap has a width W. The width W of the gap may be such that a ratio of the thickness T of the thrust plate 208 to the width W of the gap may be greater than 2:1. It should be noted that the width W of the gap allows for a clearance between the thrust plate 208 and the gear 204. At the same time, the width W bears a relation with the thickness T of the thrust plate 208 such that the thrust plate 208 is prevented from falling out of the recess 210 provided within the housing 106, especially during vibrations experienced due to the operation of the system.

### INDUSTRIAL APPLICABILITY

The thrust plate of the present disclosure is intended as a sacrificial surface used between the rotating component and the housing. The thrust plate prevents friction and wear of the housing and/or the rotating component when the rotating component comes in contact and rubs against the housing during operation. Known system designs include using a dowel pin or bolt as the retention means to fasten the thrust plate against the housing, thereby retaining the thrust plate in a stationary position with respect to the housing. This requires providing bores on the thrust plate and the housing for receiving the retention means.

The thrust plate 208 provided in the present disclosure has a non-circular profile which allows for the thrust plate 208 to be held in a stationary position relative to the rotating component. In other words, the non-circular profile of the thrust plate 208 prevents the rotation of the thrust plate 208 relative to the housing 106. Also, the relation of the thickness T of the thrust plate 208 and the width W of the gap created between the thrust plate 208 and the rotating component is such that the thrust plate 208 is prevented from falling out of the housing 106 during operation of the assembly.

This disclosure may find use in a variety of engine applications in which assembly space is limited. The solution provided herein is cost effective and does not require extra machining as in the case of when the dowel pin or bolt is used to secure the thrust plate 208.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system comprising:
a housing having a recess formed therein; and
a thrust plate positioned within the recess in the housing, the thrust plate having a non-circular profile for preventing rotation of the thrust plate relative to the housing.

2. The system of claim 1, wherein the thrust plate includes a body that is generally annular in shape with an outer radial surface and an inner radial surface, and wherein the body includes a first planar surface and a second planar surface, the second planar surface spaced from and generally parallel to the first planar surface, the thrust plate further comprising:
an ear extending from the body, the ear having surfaces that are coplanar with the first and second planar surfaces of the body.

3. The system of claim 2, wherein the ear extends from one of the outer radial surface and the inner radial surface of the body.

4. The system of claim 2, wherein first and second ears extend from the body of the thrust plate, the ears being disposed diametrically opposite one another.

5. The system of claim 1 further comprising a rotating component positioned adjacent and in spaced relation to the housing.

6. The system of claim 5, wherein the thrust plate has a thickness T, and a gap is formed between the housing and the rotating component, the gap having a width W that is smaller than the thickness T of the thrust plate.

7. The system of claim 6, wherein the ratio of the thickness T of the thrust plate to the width W of the gap between the housing and the rotating component is greater than 2:1.

8. The system of claim 6, wherein the recess in the housing has a depth D that is equal to or less than the thickness T of the thrust plate.

9. The system of claim 1, wherein the thrust plate is made of a first material and the housing is made of a second material, the first and second materials being different.

10. A thrust plate comprising:
a body having a generally circular outer periphery, a first planar surface and a second planar surface, the second planar surface spaced from and generally parallel to the first planar surface; and
an ear extending from the outer periphery of the body, the ear having surfaces that are coplanar with the first and second planar surfaces of the body.

11. The thrust plate of claim 10, wherein the ear has an arcuate outer profile.

12. The thrust plate of claim 10, wherein first and second ears extend from the outer periphery of the body, the first and second ears being disposed diametrically opposite one another.

13. The thrust plate of claim 10, wherein the thrust plate is made of a wear resistant material.

14. An engine comprising:
an engine block;
a flywheel;
a flywheel housing with a recess;
a rotating component provided in spaced relation to the flywheel housing; and
a thrust plate provided in the recess, the thrust plate including:
a body having a generally circular outer periphery, a first planar surface and a second planar surface, the second planar surface spaced from and generally parallel to the first planar surface; and
an ear extending from the outer periphery of the body, the ear having surfaces that are coplanar with the first and second planar surfaces of the body.

15. The engine of claim 14, wherein the ear has an arcuate outer profile.

16. The engine of claim 14, wherein first and second ears extend from the outer periphery of the body, the first and second ears being disposed diametrically opposite one another.

17. The engine of claim 14, wherein the thrust plate has a thickness T, and a gap is formed between the flywheel housing and the rotating component, the gap having a width W that is smaller than the thickness T of the thrust plate.

18. The engine of claim 17, wherein the ratio of the thickness T of the thrust plate to the width W of the gap between the flywheel housing and the rotating component is greater than 2:1.

19. The engine of claim 17, wherein the recess in the flywheel housing has a depth D that is equal to or less than the thickness T of the thrust plate.

20. The engine of claim 14, wherein the thrust plate is made of a wear resistant material.
